(19) United States
(12) Patent Application Publication
(10) Pub. No.: US 2005/0229231 A1
(43) Pub. Date: Oct. 13, 2005

(54) Converter-assisted video encoder

(76) Inventor: Louis A. Lippincott, Los Altos, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/816,031

(22) Filed: Mar. 31, 2004

(51) Int. Cl. H04N 7/173; G06F 13/00; H04N 5/445; H04N 7/16

(52) U.S. Cl. 725/131; 725/100; 725/139; 725/151; 725/116

(57) ABSTRACT

A system may include a decoder, an encoder, and a storage device. The decoder may decode encoded video information having a first format into intermediate video information. The decoder may also extract motion vectors from the encoded video information. The encoder may encode the intermediate video information into output video information having a second format. The encoder may use the motion vectors extracted from the encoded video information to perform its encoding. The storage device may store the output video information from the encoder.

### BACKGROUND

The implementations of the claimed invention relate to media encoding and, more particularly, to encoding received video information.

Several reasons may exist for one to encode video information. In some cases, one may wish to transcode or re-encode the video information from one format to another format for storage and/or display. Such transcoding or re-encoding may involve direct conversion of video information from a first format to a second format that differs in some way from the first format. Alternately, it may involve decoding the first format to a third, intermediate format and then encoding the third format to the second format. In other cases, one may wish to store video information for later use at a certain quality level. Other reasons, not specifically mentioned here, may exist for desiring to encode video information.

Encoding video information at high quality levels, however, may necessitate a relatively large amount of processing power. Further, technical impediments may hinder encoding of certain video information.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 illustrates an example system consistent with the principles of the invention;

FIG. 2 illustrates one example implementation of a portion of the system of FIG. 1; and

FIG. 3 is a flow chart illustrating a process of encoding video information consistent with the principles of the invention.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well-known devices, circuits, and methods are omitted so as not to obscure the description of the present invention with unnecessary detail.

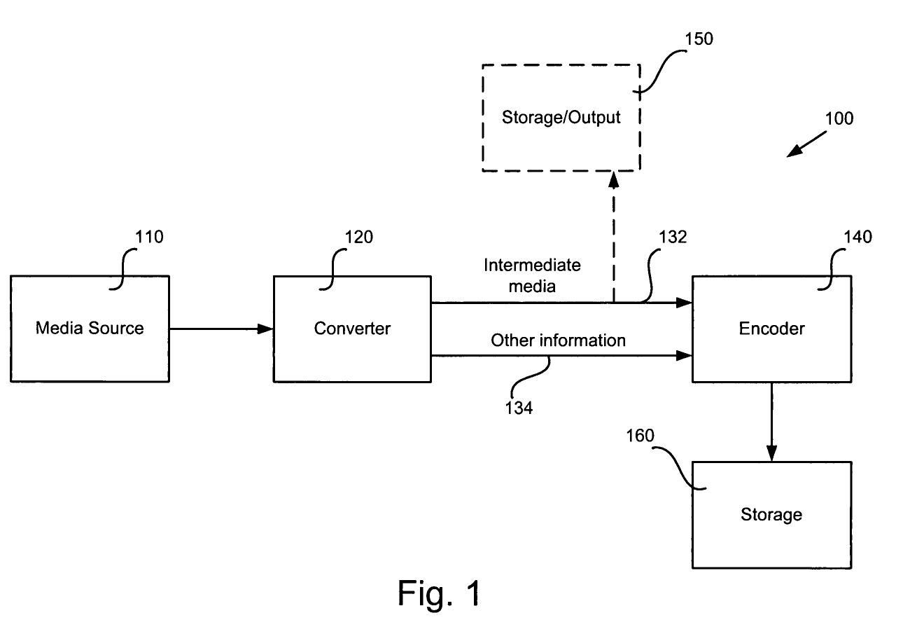

FIG. 1 illustrates an example system 100 consistent with the principles of the invention. Example implementations of system 100 may include personal video recorders (PVRs) or digital versatile disc recorders (DVD-Rs), although the claimed invention is not limited in this regard. For example, system 100 may be embodied within a general-purpose computer, a portable device, or another electrical system. Although system 100 may be embodied in a single device, in some implementations certain components of system 100 may be remote and/or physically separated from other components of system 100. Further, although system 100 is illustrated as including discrete components, these components may be implemented in hardware, software/firmware, or some combination thereof. When implemented in hardware, some components of system 100 may be combined in a certain chip or device.

System 100 may include a media source 110, a converter 120, an encoder 140, an optional storage/output 150, and a storage device 160. Converter 120 may send intermediate media information 132 to encoder 140 and to optional storage/output 150, if present. Converter 120 also may send other information 134 to encoder 140, and in some implementations other information 134 may include meta-information relating to intermediate media information 132.

Media source 110 may include a device that provides media information to the remainder of system 100. The media information provided by media source 110 may include video information encoded in a format such as MPEG-1, MPEG-2, MPEG-4, H.264, Windows Media Video version 9 (WMV9) and Advanced Video System (AVS) formats. The claimed invention is not limited to the formats specifically mentioned herein; rather any now-known or later-developed media format may be used in accordance with the schemes taught herein. In some implementations, the media information provided by media source 110 may include motion vectors.

In some implementations, media source 110 may include a tuner to separate a stream or channel of video information (e.g., high definition (HD) MPEG-2 information) from other streams or channels of media information. In some implementations, media source 110 may include a reader to read the media information from a storage medium. For example, such a reader may include an optical, magnetic, and/or electrical reader to extract the video information from a DVD, hard disk, semiconductor storage device, or other storage medium.

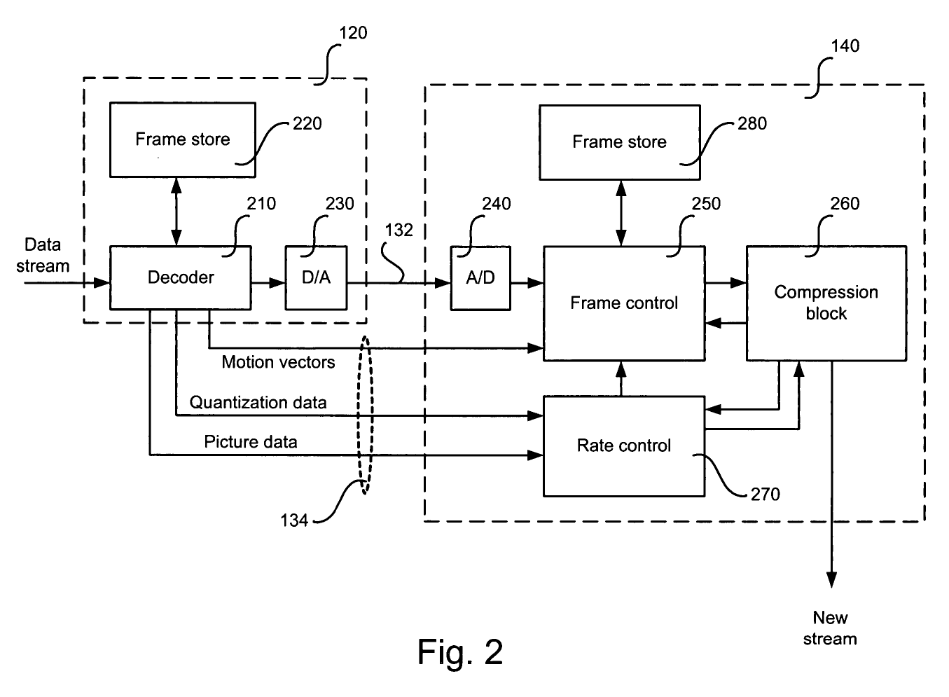

Converter 120 may convert the video information from media source 110 into intermediate media information 132 and other information 134. In some implementations, converter 120 may extract other information 134 from the video information from media source 110 before the video information is converted into intermediate media information 132. In some implementations, converter 120 may decode the video information (e.g., substantially reverse its encoding) into intermediate media information 132. In some implementations, converter 120 may transform the video information (e.g., modify without reversing its encoding) into intermediate media information 132. One possible implementation of converter 120 is illustrated in FIG. 2.

FIG. 2 illustrates one example implementation of a portion of system 100. Converter 120 in FIG. 2 may include a decoder 210, a frame store 220, and a digital to analog (D/A) converter 230. Decoder 210 may decode video information from an input data stream to output a decompressed video steam of pixels to D/A converter 230. Purely for the purposes of explanation, decoder 210 may decode, for example, HD information encoded in MPEG-2 format to a digital version of another format, such as the National Television System Committee (NTSC) standard, the Phase Alternating Line (PAL) standard, or a higher-resolution video format, although the claimed invention is not limited in this regard.

Decoder 210 may also extract other information 134 from its input video information. Such other information 134 may include motion vectors that describe displacements of macroblocks within the video information. Such motion vectors may be generated by the original encoder of the video information, and may be extracted from the information by decoder 210. Decoder 210 may also extract quantization data (e.g., used in variable uniform quantization of discrete cosine transform (DCT) coefficients to reduce the number of bits required to represent them) and picture data (e.g., whether a certain frame includes an intracoded (I) picture, a predicted (P) picture, or a bi-directionally predicted (B) picture). In some implementations, decoder 210 may not include certain information (e.g., a broadcast flag or other rights management information) in other information 134, instead focusing on information that may be re-used to later encode the video information.

Decoder 210 may use frame store 220 to buffer information as needed during its decoding and other processing. D/A converter 230 may receive the decompressed video steam of pixels from decoder 210, and may convert the stream to an analog signal (e.g., intermediate media information 132). Because of the nature of D/A conversion, D/A converter 230 may introduce some error into the analog intermediate media information 132 relative to the decompressed video steam of pixels received from decoder 210.

Although other information 134 in FIG. 2 may include motion vectors, quantization data, and picture data, such data may be characteristic of the example format (e.g., MPEG-2) described, and should not be construed to limit the claimed invention. Other formats of video information may include information instead of, or in addition to, motion vectors, quantization data, and picture data that decoder 210 may extract and include in other information 134. Similarly, although in FIG. 2 intermediate media information 132 may include analog video, in other implementations, converter 120 in FIG. 2 may not include one or more of decoder 210 and D/A converter 230. Thus, in some implementations, intermediate media information 132 may not include analog video.

Returning to FIG. 1, encoder 140 may encode intermediate media information 132 by using other information 134 to generate output video information. In some implementations, encoder 140 may encode intermediate media information 132 into the same format as the original video information from media source 110 (e.g., re-encoding), with or without an intentional change in quality of the output video information. In some implementations, encoder 140 may encode intermediate media information 132 into a different format than the original video information from media source 110 (e.g., transcoding), with or without an intentional change in quality of the output video information. One possible implementation of encoder 140 is illustrated in FIG. 2.

In FIG. 2, encoder 140 may include an analog to digital (A/D) converter 240, a frame control block 250, a compression block 260, a rate control block 270, and a frame store 280. Purely for the purposes of explanation, encoder 140 in FIG. 2 may encode, for example, HD information in MPEG-2 format, although the claimed invention is not limited in this regard.

A/D converter 240 may convert the analog intermediate media information 132 into a corresponding stream of digital pixels. A/D converter 240, however, may introduce some quantization error in the conversion. Hence, the stream of digital pixels leaving A/D converter 240 may be different from the digital pixels entering D/A converter 230 due to the double conversion. The digital pixels from A/D converter 240 may be close enough, however, to allow reuse of the motion vectors, quantization data and picture data (e.g., other information 234) from decoder 210.

Frame control block 250 may control the capture of the digital pixel stream from A/D converter 240 and may send the data to the compression block 260. Frame control block 250 may use frame store 280 to buffer information as needed during its processing. The data fed to compression block 260 may be blocks of pixels pointed to by the motion vectors after they have been decoded, as well as any error data associated with the block of pixels. In some implementations, the associated error data may be recreated by frame control block 250. In some implementations, however, the associated error data may be included in other information 134 extracted by decoder 210.

Rate control block 270 may receive the quantization data and the picture data in other information 134 from decoder 210. If, for example, the picture data indicates that a particular frame is an I frame or that a particular block is coded as an intra-frame block, then the block of pixels may be fed directly from frame control block 250 to compression block 260. Compression block 260 may be arranged to compress/encode received picture information via certain schemes, such as DCT, quantization, and variable length coding (VLC) operations in the case of MPEG-2 encoded data.

Because the digital pixels in frame store 280 of encoder 140 may be different from the corresponding pixels in the frame store 220 of the converter 120, the error data also may be different. This difference in error data may result in different data rates for the compressed stream output by compression block 260. Rate control block 270 may be designed to increase the quantization parameters when needed to bring the bit rate down to a target bit rate. Similarly, rate control block 270 may modify the quantization parameters, if needed, to increase the output bit rate of compression block 260. Otherwise, the rate control block 270 may follow the clues given to it by decoder 210 in the quantization data in other information 134.

Frame control block 250's reuse of the motion vectors extracted from the original video stream allows compression block 260 to eliminate motion estimation processing, saving numerous computations. In some implementations, compression block 260 may perform a relatively simple, localized motion search to compensate for errors introduced by A/D converter 240's re-digitization of the pixels. For example, in typical video compression the block matching may involve searching over a fairly large area. Typically, 100×70 pixel search windows may be used, with matching done at sub-pixel levels, necessitating many billions of operations per second. Reusing the motion vectors in other information 134 from decoder 210 may permit frame control block 250 to use a much smaller search window, perhaps as small as +2 pixels, to compensate for the errors introduced in the D/A and A/D conversions.

The operation of rate control block 270 also may be significantly reduced by the reuse of the quantization data and picture data in other information 134 that is extracted from the original stream. Even though the stream of output video information generated by compression block 260 may not match the original stream input to decoder 210, a user may experience substantially the same video quality when the output video information is played back. The schemes described herein enable a design of encoder 140 that is less complex and needs less computational power than would be possible otherwise.

Although encoder 140 in FIG. 2 may include certain components, such may be characteristic of the example encoding format (e.g., MPEG-2) described, and should not be construed to limit the claimed invention. Other encoding formats for the received intermediate media information 132 may involve additional or alternative components to elements 240-280 illustrated in FIG. 2.

Returning to FIG. 1, optional storage/output 150 may be arranged to store or output intermediate media information 132. In some implementations, storage/output 150 may include an output interface to provide another system or another component of system 100 (not shown) access to intermediate media information 132. Such a physical output interface may be optical, electrical, etc., and may conform to one or more existing interface specifications for video information.

In some implementations, storage/output 150 may include a storage device for storing intermediate media information 132. For example, storage/output 150 may include a hard disk or flash memory to store information 132. In some implementations, storage/output 150 may include a writeable optical drive (e.g., DVD-RW, etc.) to transfer intermediate media information 132 to a portable storage medium. In some implementations, optional storage/output 150 may not be present, and intermediate media information 132 may be used only by encoder 140.

Storage 160 may include a storage device for storing the encoded video information output by encoder 140. A processor (not shown) may access the encoded video information in storage 160 for playback or some other purpose at a later time. In some implementations, storage 160 may include a hard disk or flash memory to store the encoded video information. In some implementations, storage 160 may include a writeable optical drive (e.g., DVD-RW, etc.) to transfer the encoded video information to an optical storage medium. Although several exemplary implementations have been discussed for storage 160, the claimed invention should not be limited to those explicitly mentioned, but instead should encompass any device capable of storing the encoded video information from encoder 140.

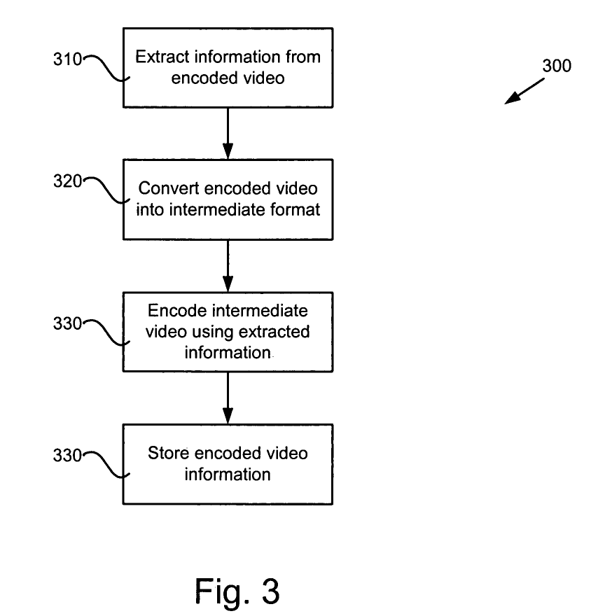

FIG. 3 is a flow chart illustrating a process 300 of encoding video information consistent with the principles of the invention. Although process 300 may be described with regard to system 100 for ease of explanation, the claimed invention is not limited in this regard. Processing may begin with converter 120 extracting other information 134 from the encoded video information that it receives from media source 110 [act 310]. Other information 134 may include, for example, motion vectors and/or other information may be computationally intensive to generate. In some implementations, other information 134 may also include further extracted information, such as quantization data, error data, and/or picture data.

Processing may continue with converter 120 converting the encoded video information into an intermediate format for intermediate media information 132 [act 320]. In some implementations, the intermediate format may include analog pixel data, as in FIG. 2. In such implementations, converter 120 may function as a decoder (e.g., decoder 210). In some implementations, the intermediate format may include digital pixel data or an encoded format that does not identically correspond to pixel data. In such implementations, converter 120 may function as a partial decoder, transcoder, etc. to perform some other conversion of the encoded video information than merely decoding it. Various intermediate formats are possible and contemplated, depending on the design and capabilities of encoder 140 to handle such formats.

Encoder 140 may encode intermediate media information 132 using other information 134 that was extracted by converter 120 [act 330]. In some implementations (e.g., in FIG. 2), encoder 140 may re-encode intermediate media information 132 into the original format of the encoded video information received by converter 120. In some implementations, encoder 140 may encode intermediate media information 132 into a different format than that of the encoded video information received by converter 120. As an example, encoder 140 may encode intermediate media information 132 that was originally in MPEG-2 format into H.264 format. Other transcodings are possible and consistent with the principles of the invention.

In some implementations, encoder 140 may use motion vectors from other information 134 to aid in encoding intermediate media information 132. Encoder 140 may also use one or more of quantization data, picture data, and/or error data, if available, in other information 134 to assist in encoding intermediate media information 132. In some implementations, encoder 140 may use any other information that is computationally expensive to regenerate and that may be extracted by converter 120, in addition to or instead of the motion vectors to aid in encoding intermediate media information 132.

Processing may continue with storage 160 storing the encoded video information output by encoder 140 [act 340]. Such storing may occur on magnetic, semiconductor, optical, or any other suitable media or device capable of storing such encoded video information. In some implementations, act 340 may include, additionally or alternately, outputting the encoded video information from encoder 140 for use (e.g., playback, transmission, by another portion of system 100 (not shown) or another system. Although not explicitly shown in FIG. 3, act 340 may also, or alternatively, include storage or output of intermediate media information 132 by storage/output 150. The schemes described herein may, in some implementations, use a combination of analog pixels and digital clues from converter 120 to re-compress or re-encode input video information.

The foregoing description of one or more implementations consistent with the principles of the invention provides illustration and description, but is not intended to be exhaustive or to limit the scope of the invention to the precise form disclosed. Modifications and variations are possible in light of the above teachings or may be acquired from practice of various implementations of the invention.

For example, any audio information in the media data input to converter 120 may be converted to analog and back to digital for re-compression by encoder 140, because the compute energy required is relatively minimal. Further, although shown as directly connected in FIG. 1, one or more of intermediate media 132 and other information 134 may be transmitted from converter 120 to encoder 140 via a wired or wireless communication link.

Moreover, the acts in FIG. 3 need not be implemented in the order shown; nor do all of the acts necessarily need to be performed. Also, those acts that are not dependent on other acts may be performed in parallel with the other acts. Further, at least some of the acts in this figure may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Where only one item is intended, the term “one” or similar language is used. Variations and modifications may be made to the above-described implementation(s) of the claimed invention without departing substantially from the spirit and principles of the invention. All such modifications and variations are intended to be included herein within the scope of this disclosure and protected by the following claims.

1. A system, comprising:
a decoder to decode encoded video information having a first format into intermediate video information and to extract motion vectors from the encoded video information;
an encoder to encode the intermediate video information into output video information having a second format using the motion vectors extracted from the encoded video information; and
a device to store the output video information from the encoder.

2. The system of claim 1, wherein the first format and the second format have a common format.

3. The system of claim 2, wherein the common format includes MPEG-1, MPEG-2, MPEG-4, H.264, Windows Media Video version 9 (WMV9) or Advanced Video System (AVS).

4. The system of claim 1, wherein the first format includes MPEG-2, and
wherein the second format includes H.264.

5. The system of claim 1, wherein the decoder is arranged to extract quantization data, picture data, or error data from the encoded video information.

6. The system of claim 1, wherein the encoder includes a digital to analog converter, and
wherein the intermediate video information includes analog pixel information.

7. The system of claim 1, wherein the intermediate video information includes digital pixel information.

8. The system of claim 1, further including:
an output port to output the intermediate video information.

9. A method, comprising:
extracting motion information from an encoded video stream;
converting the encoded video stream to an intermediate video stream; and
encoding the intermediate video stream into an output video stream using the motion information extracted from the encoded video stream.

10. The method of claim 9, wherein the extracting includes:
obtaining quantization data or picture data from the encoded video stream, and
wherein the encoding includes encoding the intermediate video steam using the motion information and the quantization data or the picture data obtained from the encoded video stream.

11. The method of claim 9, wherein the converting includes:
decoding the encoded video stream to generate a stream of uncompressed pixel data.

12. The method of claim 11, wherein the converting further includes:
converting the stream of uncompressed pixel data to analog form to generate the intermediate video stream.

13. The method of claim 9, wherein the encoded video stream and the output video stream share a common encoding format.

14. The method of claim 9, wherein the encoded video stream and the output video stream have different encoding formats.

15. The method of claim 9, further comprising:
storing the output video stream.

16. The method of claim 9, further comprising:
storing the intermediate video stream.

17. An apparatus, comprising:
a converter to convert input media information into intermediate media information having an intermediate format and to extract other information from the input media information; and
an encoder to encode the intermediate media information into output media information having an output format using the other information extracted from the input media information.

18. The apparatus of claim 17, wherein the input media information is encoded in the output format.

19. The apparatus of claim 17, wherein the input media information is encoded an input format that is different from the output format.

20. The apparatus of claim 17, wherein the intermediate media information includes analog data.

21. The apparatus of claim 17, wherein the input media information is encoded, and
wherein the converter includes a decoder to decode the encoded input media information to generate the intermediate media information.

22. The apparatus of claim 17, wherein the other information includes motion vectors.

23. The apparatus of claim 17, further comprising:
a storage device to store the output media information from the encoder.

24. A method, comprising:
obtaining at least motion vectors from an encoded video stream;
decoding the encoded video stream to generate an analog video stream; and
encoding the analog video stream to generate an output video stream using the motion vectors obtained from the encoded video stream.

25. The method of claim 24, wherein the obtaining further includes obtaining quantization data and picture data from the encoded video stream.

26. The method of claim 25, further comprising:
controlling a rate of the encoding using the quantization data and the picture data.

27. The method of claim 24, further comprising:
storing the output video stream.
